(19) United States
(12) Patent Application Publication
(10) Pub. No.: US 2026/0223219 A1
(43) Pub. Date: Jul. 30, 2026

(54) MULTI-NODE SUBSCRIBER MESSAGES

(71) Applicant: Infineon Technologies AG, Neubiberg (DE)

(72) Inventors: Daniel MYSLIWITZ, München (DE); Martin KILIAN, Unterhaching (DE)

(21) Appl. No.: 19/041,538

(22) Filed: Jan. 30, 2025

(51) Int. Cl. H04W 76/15

(52) U.S. Cl. CPC H04W 76/15

(57) ABSTRACT

A responder node of a serial communications system is configured to receive a header part of a subscriber message frame with an identifier field that specifies the responder node is to send reply data to a commander node. During a response part of the subscriber message frame, the responder node sends reply data along with other reply data from at least one other responder node specified by the identifier field.

### TECHNICAL FIELD OF THE INVENTION

This invention relates generally to communications protocols, and more specifically to serial communications protocols like a Local Interconnect Network (LIN) protocol.

### BACKGROUND

Some applications, in particular automotive applications, may use serial communications network configured to communicate using a protocol like a Local Interconnect Network (LIN) protocol. For example, such a serial communications network may be used to implement motor control, battery management, power conversion, or other automotive systems.

According to a traditional serial communications network a commander node may request data from one of multiple responder nodes by sending a subscriber message frame which includes a header part and a response part. The header part includes a protected identifier field that identifies one of the multiple responder nodes to send data in response. If the protected identifier field of a subscriber message frame corresponds to a particular responder node, the identified responder node sends reply data during the response part of the same subscriber message frame. In such a traditional communications network, to solicit and receive reply data from multiple responder nodes of a serial communications system, the commander node sends a dedicated subscriber message frame directed to each of the multiple responder nodes.

In some examples, a traditional serial data protocol may be unsuitable for applications that operate at relatively fast speeds and/or that employ a large number of responder nodes, requiring other forms of communication (e.g., ethernet, coaxial, etc.) that may be more costly/complex to implement and/or that consume more energy than serial communication systems. A need exists for improved techniques that enable serial communication to support a wider range of applications.

### SUMMARY

In some aspects, a method includes receiving, by a responder node, a header part of a subscriber message frame with an identifier field that specifies the responder node is to send reply data to a commander node. The method further includes sending, by the responder node during a response part of the subscriber message frame, the reply data along with other reply data from at least one other responder node specified by the identifier field.

In some aspects, a method includes sending a header part of a subscriber message frame with an identifier field that specifies multiple responder nodes of a communications network to send reply data. The method further includes receiving, in a response part of the subscriber message frame, the reply data from the multiple responder nodes specified by the identifier field.

In some aspects, a communications system includes a commander node configured to send a header of a subscriber message frame with an identifier field that specifies that multiple responder nodes are to send reply data to the commander node. The system further includes multiple responder nodes that are configured to send reply data to the commander node in a responder part of the subscriber message frame.

In some aspects, a responder node is configured to receive a header of a subscriber message frame with an identifier field that specifies the responder node is to send reply data to a commander node. The responder node is further configured to send the reply data as part of a reply message frame that includes other reply data from at least one other responder node specified by the identifier field of the subscriber message frame.

In some aspects, a commander node is configured to send a subscriber message frame with a header that includes an identifier field that specifies multiple responder nodes of a communications network to send reply data. The commander node is further configured to receive reply data from the multiple responder nodes specified by the identifier field in a response part of the subscriber message frame.

### BRIEF DESCRIPTION OF THE DRAWINGS

FIG. 1 is a block diagram showing one example of a serial communications system.

FIG. 2 is a block diagram depicting one example of a subscriber message frame according to some embodiments.

FIG. 3 is a block diagram depicting one example of a subscriber message frame with reply data that includes one or more additional checksum bits according to some embodiments.

FIG. 4 is a flow diagram that depicts one example of a method of operating a responder node of a communications system to append reply data according to some embodiments.

FIG. 5 is a flow diagram that depicts one example of a method of operating a responder node of a communications system using a serial communications protocol according to some embodiments.

FIG. 6 is a flow diagram that depicts one example of a method of operating a commander node of a communications system using a serial communications protocol according to some embodiments.

### DETAILED DESCRIPTION

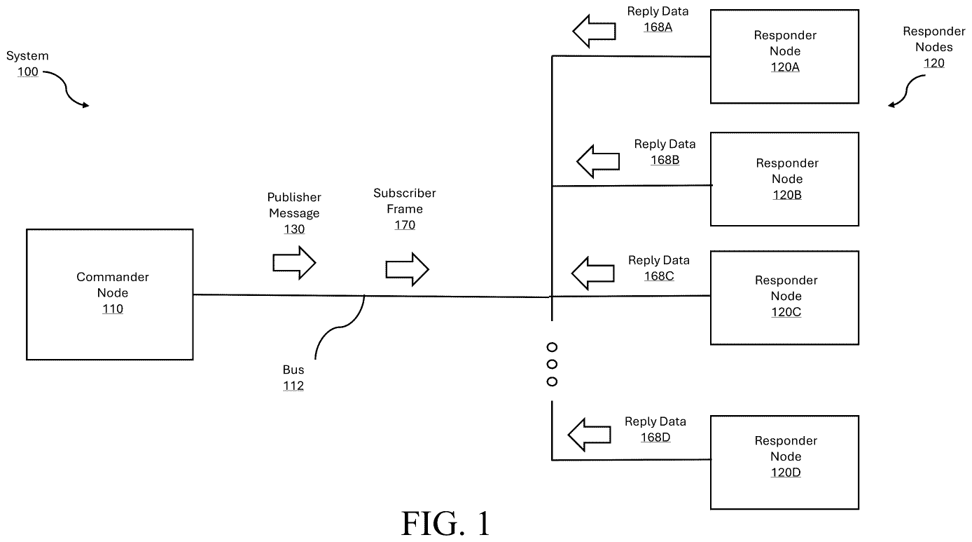

FIG. 1 is a block diagram showing one example of a serial communications system 100. As shown in FIG. 1, the system includes multiple responder nodes 120 that are coupled via a communications bus 112 to communication with a commander node 110. The communications bus 112 may include one or multiple conductors and is shared by the respective nodes 110, 120 of system 100 to communicate. System 100 may be implemented using a relatively low cost/low power communications protocol such as a serial communications protocol. In a non-limiting example, system 100 may be configured to use a Local Interconnect Network (LIN) protocol to communicate.

In the example of FIG. 1, system 100 includes a number of N responder nodes 120A-120D that are each coupled to the commander node 110 to communicate. For simplicity, the example of FIG. 1 shows a system 100 with N=4 responder nodes. In other examples, system 100 may include any number of N responder nodes. For example, system 100 may include from N=1 up to N=127, or an even greater number of responder nodes.

In the example of FIG. 1, the commander node 110 is configured to communicate with the responder nodes 120 by sending messages to the responder nodes 120. For example, the commander node 110 may send a publisher message 130 to send commands or other data to each of the responder nodes 120. In some examples, publisher messages 130 from the commander node 110 are one-way, i.e., the responder nodes 120 may store data received through a publisher message 130, or execute a command received in a publisher message 130, but do not send a message in response to a publisher message 130 from the commander node 110.

In traditional examples of a serial communications network, in order to solicit reply data from multiple responder nodes, a commander node sends a different subscriber message frame with a unique header part to each of the responder nodes, which send reply data during a response of each respective subscribed message frame. As one example, according to traditional implementations of a serial communications protocol, in order to receive reply data from a number of M responder nodes, the commander node may send the same number of M subscriber message frames to solicit and receive reply data from the M responder nodes during the responder parts of the respective M subscriber message frames.

System 100 depicted in FIG. 1 is uniquely configured such that the commander node 110 may solicit and receive a reply from multiple responder nodes with the same subscriber message frame 170, instead of sending different subscriber message frames to each responder node like with traditional serial communication implementations.

According to the FIG. 1 example, the commander node 110 sends a subscriber message frame 170 with a header part that specifies multiple responder nodes 120 to send reply data in response. The multiple responder nodes 120 may include a total number of N responder nodes 120A-120D of the system 100, or less than the total number of N responder nodes of the system 100. In response to receipt of the header part, the multiple responder nodes send reply data 168A-168D during a response part of the subscriber message frame 170. For example, each of the multiple responder nodes may append reply data 168A-168D along with reply data from at least one other responder node during the response part of the subscriber message frame 170. In some examples, the responder nodes 120 may append the reply data 168A-168D in an order defined by the header part of the subscriber message frame 170.

In some examples, by operating as described, the commander node 110 of system 100 may solicit and receive reply data 168A-168D from multiple nodes 120 more efficiently than traditional serial communications systems, i.e, the commander node 110 may solicit and receive the reply data 168A-168D with fewer messages and/or fewer bits of data. Accordingly, system 100 may be implemented to support applications configured to operate at relatively fast speeds and/or or that support a greater number of responder nodes than in traditional serial communications systems are capable of supporting.

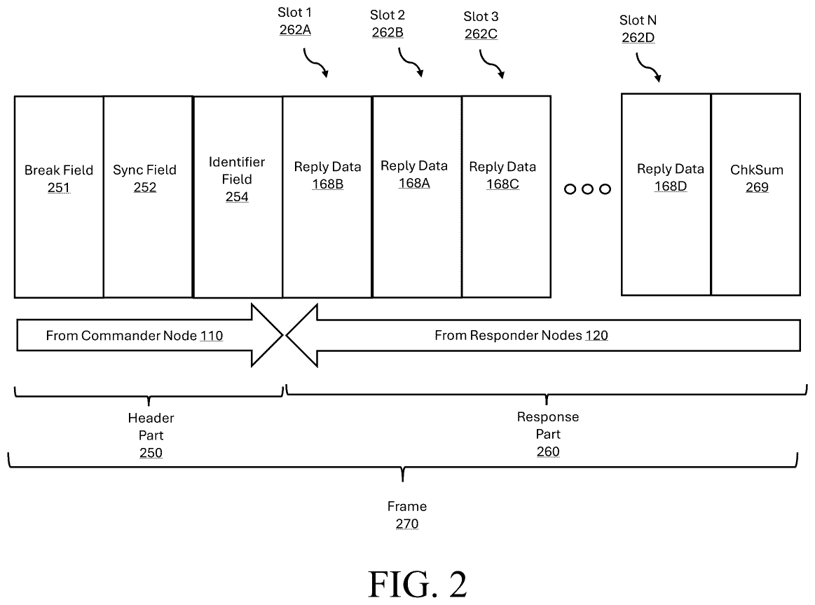

FIG. 2 is a block diagram depicting one example of a subscriber message frame 270 according to some embodiments. The subscriber message frame 270 shown in FIG. 2 generally corresponds to the subscriber message frame 170 depicted in FIG. 1 and may be used by a commander node 110 of the system 100 to solicit reply data 168A-168D from multiple responder nodes 120 of the system 100.

As shown in FIG. 2, the subscriber message frame 270 includes a header part 250 and a response part 260. As shown in FIG. 2, the header part 250 is sent by the commander node 110, for example to the N responder nodes 120A-120D of system 100 via the communications bus 112 as one example. As shown in FIG. 2, the header includes a break field 251, a sync field 252, and an identifier field 254. The break field 251 is configured to indicate the beginning of the frame 270 being communicated and may include a start of frame (SOF) bit and/or other bits representing other data or commands. As shown in FIG. 2, the header part 250 also include a synchronization field 252, which may include one or more bits used by the responder nodes 120A-120D to synchronize with a clock of the commander node 110. As shown in FIG. 2, the header part 250 also includes an identifier field 254.

In the example of FIG. 2, the identifier field 254 is uniquely configured to specify multiple responder nodes of system 100 to send reply data 168A-168D, and an order in which the responder nodes should send the reply data 168A-168D, during the response part 260 of a subscriber message frame 270. Referring to the example of FIG. 1, the multiple responder nodes indicated by the identifier field 254 may include all N responder nodes 120A-120D of the system 100. In other examples, the multiple responder nodes may correspond to less than the total number of N responder nodes 120A-120D of system 100.

As shown in FIG. 2, the response part 260 of the subscriber message frame 270 includes a plurality of data slots 262A-262D. The plurality of slots 262A-262D may include the same or a different number of bits and are each associated with one or multiple responder nodes 120 identified by the identifier field 254. In some examples, each of the plurality of slots 262A-262D includes a byte of data, i.e., eight binary bits of data. In other examples, each of the plurality of slots 262A-262D may have more or fewer bits of data. For example, each of the slots 262A-262D may include two or more bytes of data in some examples.

In some examples, each of the multiple identified responder nodes may include a memory configured to store configuration data that maps different values of the identifier field 254 to different actions of the respective responder node. In some examples, the responder nodes 120A-120D each include configuration data that maps the value for the identifier field 254 that identifies which of the responder nodes 120A-120D should send reply data and an order in which the of the identified responder nodes should send the reply data.

In some examples, configuration data is stored in a memory of each of the N responder nodes 120A-120D of system 100 and accessed by each respective responder node to define communications. For example, the configuration data may be from one or more configuration files loaded into a memory component of each of the N responder nodes 120A-120D when the respective responder nodes are initialized as part of a setup and/or reset routine of the system 100. In some examples where system 100 is configured to communicate using a LIN serial communications protocol as described above, such a configuration file may include a LIN Description File (LDF) or other type of configuration file loaded into a memory of the N respective responder nodes 120A-120D.

In some examples, more than one value for the identifier field 254 may be included in the configuration data of each respective responder node 120A-120D that map to different groupings of responder nodes to send reply data and/or different orders in which the respective responder nodes should send the reply data.

As one example referring to FIG. 1, a first value for the identifier field 254 may map to responder nodes 120A and 120B appending reply data 168A, 168B in the response part 260 of a first subscriber message frame 270 and/or an order in which the responder nodes 120A and 120B should append the reply data 168A, 168B. A second value of the identifier field 254 may map to responder nodes 120C and 120D appending reply data 168C, 168D in the response part 260 of a second subscriber message frame 270 and/or an order in which the responder nodes 120C and 120D should append the reply data 168C, 168D. Accordingly, the commander node 110 may solicit reply data from different groupings of multiple responder nodes using different values for the identifier field 254 stored in the configuration data. As a non-limiting example, a system with sixteen responder nodes may include configuration data with four different identifier field 254 values that each map to a grouping and/or order of four of the sixteen responder nodes to send reply data. According to this example, the commander node 110 may solicit reply data from the sixteen responder nodes by sending four different subscriber message frames, and receiving reply data during the response part of each of the four different subscriber message frames.

In another non-limiting example, a system with the same number of sixteen responder nodes may include configuration data with two different identifier field 254 values that each map to a grouping of eight responder nodes. According to this example, the commander node 110 may solicit reply data from the sixteen responder nodes by sending two different subscriber message frames, and receiving reply data appended by eight responder nodes during the response part of each of the two different subscriber message frames. In still other examples, a commander node 110 may be configured to solicit reply data from responder nodes of systems with different numbers of N responder nodes with the same or different groupings of the N responder nodes.

As described above, the identifier field 254 may also specify (i.e., map to) an order in which each responder node should append reply data relative to other responder nodes during the response part 260 of the frame 270, e.g., an order relative to in the slots 268A-268D of the response part 260 of the frame 270.

In some examples, the configuration data associated with a particular identifier field 254 value is unique to each responder node. For example, the identifier field 254 value may map to configuration data that identifies a responder node that precedes the responder node in the order (e.g., so that each node appends reply data after the reply data of the prior node is appended), and/or that the particular responder node is first in the order (e.g., so that the particular responder node should append reply data in the first slot 262A in the response part 260 of the subscriber message frame 270.

A non-limiting example of an order specified by the identifier field 254 of a subscriber message frame 270 is shown in FIG. 2. According to this example, the identifier field 254 may specify that each of the N responder nodes 120A-120D depicted in FIG. 1 are to send reply data 168A-168D.

In some examples, a value of the identifier field 254 may map to configuration data unique to each of the responder nodes 120A-120D. According to the example shown in FIG. 2, the value of the identifier field 254 may map to configuration data stored in responder node 120B that indicates responder node 120B is first in the order. The value of the identifier field 254 may further map to configuration data stored in responder node 120A that specifies responder node 120A is after node 120B in the order. The value of the identifier field 254 may further map to configuration data stored in responder node 120C that responder node 120C is after node 120A in the order. The value of the identifier field 254 may further map to configuration data stored in responder node 120D that responder node 120D is after responder node 120C in the order.

In some examples, when the header part 250 is received by the responder nodes 120A-120D, each responder node 120A-120D may append reply data in slots 262A-262D of the response part 260 according to the order defined by mapping the identifier field 254 value to the configuration data for the respective responder node. According to the non-limiting example described above, since responder node 120B is first in the order, the responder node 120B may append reply data 168B in the first slot 262A of the response part 260. Once the reply data 168B has been appended in the first slot 262A, responder node 120A may append reply data 168A in the second slot 262B of the response part 260. Once the reply data 168A has been appended in slot 262B, responder node 120C may append reply data 168C in the third slot 262C of the response part 260. Once the reply data 168C has been appended in slot 262C, the responder node 120D may append reply data 168D in the fourth slot 262D of the response part 260.

As also shown in FIG. 2, the responder part 260 of the subscriber message frame 270 includes one or more checksum bits 269. As shown in FIG. 2, the checksum bits 269 may follow the reply data 168A-168D in the slots 262A-262D in the response part 260. In some examples, each of the responder nodes 120A-120D identified to send reply data as part of the subscriber message frame 270 may output the checksum bits 269 after a last responder node in the order has appended reply data (responder node 120D in the FIG. 2 example). In some examples, a commander node 110 may monitor the checksum bits 269 at an end of each subscriber message frame 270 after the reply data 168A-168D has been appended to detect any mismatch between the checksum bits 269 from each of the responder nodes 120A-120D. If a mismatch is detected, the commander node 110 may determine that a transmission error occurred. In some examples, the commander node 110 may take steps to mitigate such a transmission error by resending the subscriber message frame 270 or taking another action to mitigate a transmission error such as resetting (e.g., including reloading configuration data) one or more responder nodes of the system 100.

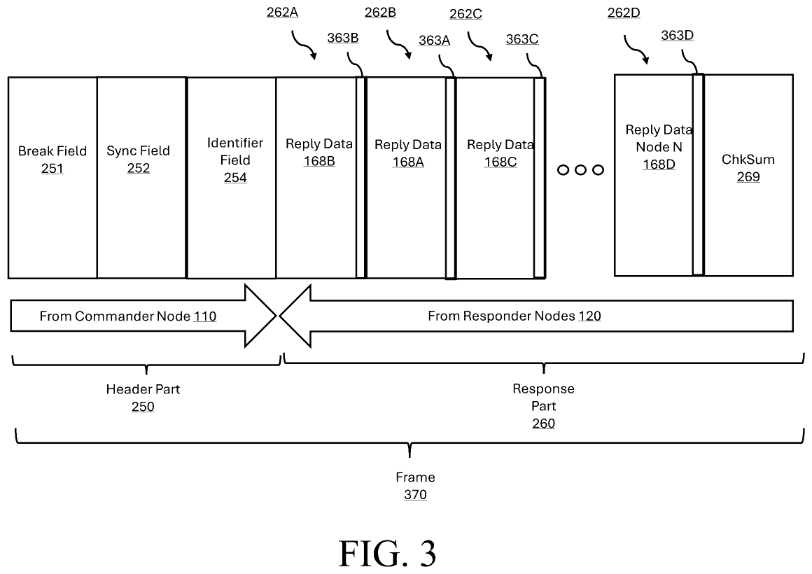

FIG. 3 is a block diagram depicting one example of a subscriber message frame 370 with reply data 168A-168D from multiple responder nodes 120A-120D that includes one or more additional checksum bits 363A-363D according to some embodiments. The example of FIG. 3 is substantially similar to the example of FIG. 2 and shows a subscriber message frame 370 with a header part 250 and a response part 260 that includes a plurality of slots 262A-262D that correspond to reply data 168A-168D from each of responder nodes 120A-120D according to an order specified by the identifier field 254 (e.g., as mapped to configuration data of each responder node that specifies the order).

The example of FIG. 3 differs from the example of FIG. 2 in that the reply data 168A-168D from each responder node 120A-120D includes additional checksum bits 363A-363D. For example, as shown in FIG. 3, as part of appending the reply data 168B in slot 262A, the responder node 120B appends one or more checksum bit(s) 363B that can be used to verify that the reply data 168B was effectively communicated. Similarly, as part of appending the reply data 168A in slot 262B, the responder node 120A outputs checksum bits 363A that can be used to verify that the reply data 168A was effectively communicated. As part of appending the reply data 168C in slot 262C, the responder node 120C outputs checksum bits 363C, and as part of appending the reply data 168D in slot 262D, the node 120D outputs checksum bits 363D. The checksum bits 363C and 363D can similarly be used to verify that the reply data 168C and 168D were effectively communicated. As shown in the FIG. 3 example, each the responder nodes 120A-120D specified to send reply data 168A-168D may also append one or more checksum bit(s) 269 after the reply data 168D which is last in the order is appended by responder node 120D as described above with respect to FIG. 2. According to the example of FIG. 3, the additional checksum bit(s) 363A-363D may be used alone, or in addition to the checksum bit(s) 269, to detect any mismatch to determine whether any transmission errors occurred when communicating the subscriber message frame 370.

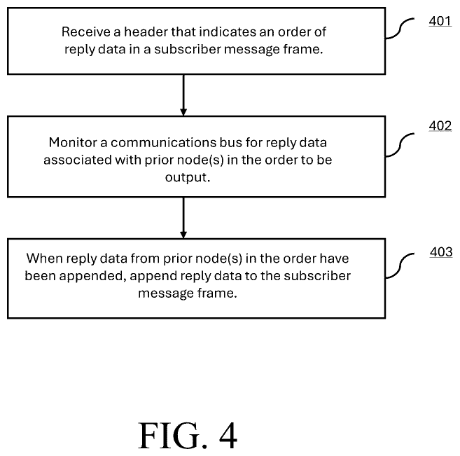

FIG. 4 is a flow diagram that depicts one example of a method of operating a responder node 120A-120D of a communications system 100 to append reply data 168A-168D according to some embodiments. As shown in FIG. 4, at 401, the method includes receiving a header part 250 of a subscriber message frame 270 that indicates an order of reply data 168A-168D in the subscriber message frame 270 from multiple responder nodes. The header part 250 may include an identifier field 254 with a value that maps to stored configuration data that indicates an order of each of the multiple responder nodes to append the reply data 168A-168D. The configuration data may be unique to each of the multiple responder nodes and identify a prior responder node in the order. According to these examples, the responder node may append reply data after reply data is appended by the prior responder node in the order.

As also shown in FIG. 4, the method further includes monitoring a communications bus 112 for reply data associated with prior responder node(s) in the order to be output. The reply data may be appended during a response part 260 of the subscriber message frame 270, and may correspond to a plurality of slots 262A-262D of the subscriber message frame 270.

As shown in FIG. 4, at 402, the responder node 120A-120D monitors the bus 112 for the reply data of the prior responder node(s). As shown in FIG. 4, at 403, if the responder node detects the reply data from the prior responder node(s) in the order have been appended via the bus 112, the responder node appends reply data to the reply data from the prior responder node(s) during the response part 260 of the subscribed message frame 270.

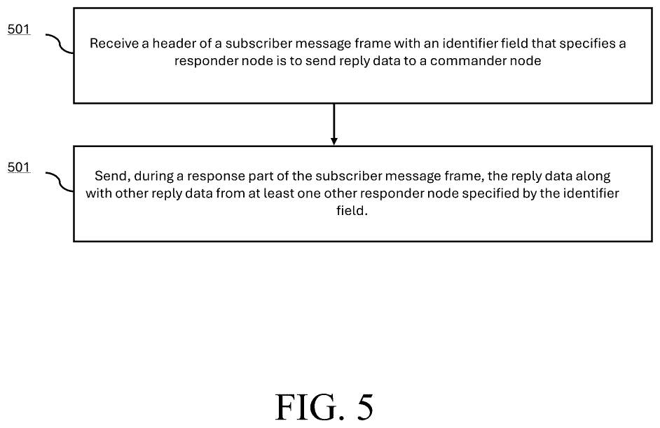

FIG. 5 is a flow diagram that depicts one example of a method of operating a responder node 120A-120D of a communications system 100 using a serial communications protocol according to some embodiments. As shown in FIG. 5, at 501, the method includes receiving a header part 250 of a subscriber message frame 270 that specifies a responder node 120A is to send reply data. For example, the header part 250 may include an identifier field 254 with a value that maps to configuration data store in the responder node 120A that specifies an order in which the responder node 120A is to append the reply data in the subscriber message frame 270 relative to other prior reply data from other responder nodes. In some examples, the identifier field 254 value maps to a prior node or nodes in the order, and the responder node appends the reply data after prior reply data from the prior node or nodes is appended as part of the response part 260 of the subscriber message frame 270.

In some examples, the method further includes sending one or more checksum bit(s) 269 at an end of the subscriber message frame 270. In some examples, the responder node 120A is one of multiple responder nodes, the method further includes sending the checksum bit(s) 269 by each of the multiple responder nodes at an end of the subscriber message frame 270. In some examples, the method further includes identifying, by a commander node 110 a transmission error if the checksum bit(s) 269 from at least one of the multiple responder nodes indicates a checksum mismatch.

In some examples, the method may include appending additional checksum bit(s) 363A-363D as part of the reply data from the multiple responder nodes. In some examples, the method includes sending first checksum bit(s) 363B as part of the reply data 168B from the responder node 120B, and sending second checksum bit(s) 363A, 363C-364D as part of the other reply data from the at least one other responder node 120A, 120C-120D. In some examples, the identifier field 254 maps to multiple responder nodes to send reply data, and the reply message frame 270 includes a plurality of data slots 262A-262D that correspond to reply data 168A-168D of the responder nodes 120A-120D. In some examples, the plurality of data slots 162A-162D each include a byte of data.

In some examples, the responder node 120A is part of a communications system 100 that includes a number of N responder nodes 120, and the identifier field 254 specifies less than all of the N responder nodes 120 to send reply data as part of the subscriber message frame 270. In some examples the identifier field 254 includes a value that maps to a configuration file that identifies multiple responder nodes 120 to send the reply data 168A-168D. In some examples the value the of the identifier field 254 maps to a configuration file that specifies an order of the reply data 168B from the responder node 120B relative to other reply data 168B-168D in the subscriber message frame 270.

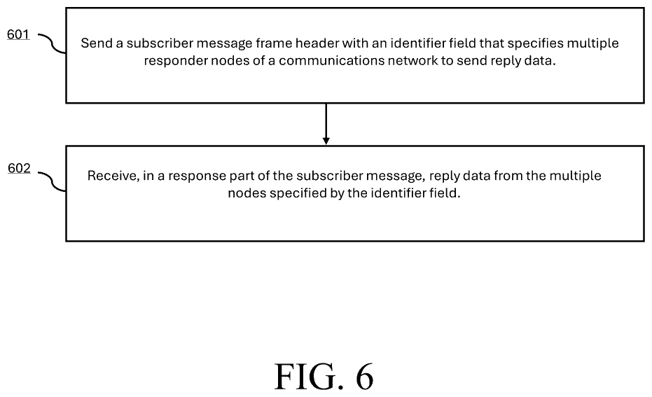

FIG. 6 is a flow diagram that depicts one example of a method of operating a commander node 110 of a communications system 100 using a serial communications protocol according to some embodiments. As shown in FIG. 6, at 601, the method includes sending a header part 260 of a subscriber message frame 270 with an identifier field 254 that specifies multiple responder nodes 120A-120D to send reply data 168A-168D. As shown in FIG. 6, at 602, the method further includes receiving, in a response part 260 of the subscriber message frame 270, reply data 168A-168D from the multiple responder nodes 120A-120D specified by the identifier field 254. In some examples, the identifier field 254 specifies an order of the reply data 168A-168D from the multiple responder nodes 120A-120D.

In some examples, the method further includes receiving one or more checksum bit(s) 163A-163D as part of the reply data 168A-168D from the multiple responder nodes. In some examples, the method further includes receiving the reply data 168A-168D from the multiple responder nodes 120A-120D in a plurality of data slots 262A-262D in the subscriber message frame 270. In some examples, the system includes a number of N responder nodes 120A-120D, and the identifier field 254 specifies less than all of the N responder nodes 120A-120D to send the reply data 168A-168D as part of the subscriber message frame 270. In some examples, the identifier field 254 includes a value that maps to a configuration file that specifies the multiple responder nodes 120A-120D are to send the subscriber message frame 270. In some examples, the configuration file specifies an order of the multiple responder nodes 120A-120D to append reply data 168A-168D in the subscriber message frame 270.

### Clauses

Clause 1. A method, comprising: receiving, by a responder node, a header part of a subscriber message frame with an identifier field that specifies the responder node is to send reply data to a commander node; and sending, by the responder node during a response part of the subscriber message frame, the reply data along with other reply data from at least one other responder node specified by the identifier field.

Clause 2. The method of clause 1, wherein the identifier field maps to an order of the reply data from the responder node relative to the other reply data in the subscriber message frame.

Clause 3. The method of clause 2, wherein the reply data is after prior reply data in the order, and the method further includes appending the reply data after the prior reply data has been output as part of the response part of the subscriber message frame.

Clause 4. The method of any of clauses 1-3, further comprising: sending one or more checksum bits at an end of the subscriber message frame.

Clause 5. The method of clause 4, wherein the responder node is one of multiple of responder nodes specified by the identifier field to send reply data, and further comprising: sending the one or more checksum bits by each of a plurality of responder nodes at an end of the subscriber message frame.

Clause 6. The method of clause 5, further comprising: identifying, by a commander node, a transmission error if the checksum bits from at least one of the multiple of responder nodes indicates a checksum mismatch.

Clause 7. The method of any of clauses 4-6, further comprising: sending first checksum bits as part of the reply data from the responder node; and sending second checksum bits as part of the other reply data from the at least one other responder node.

Clause 8. The method of any of clauses 1-7, wherein identifier field maps to a multiple responder nodes to send reply data, and response part of the subscriber message frame includes a plurality of data slots that correspond to reply data of the multiple responder nodes.

Clause 9. The method of clause 8, wherein the plurality of data slots each include at least a byte of data.

Clause 10. The method of any of clauses 1-9, wherein the responder node is part of a communications system that includes a number of N responder nodes, and the identifier field specifies less than all of the N responder nodes to send reply data as part of the subscriber message frame.

Clause 11. The method of any of clauses 1-10, wherein the identifier field includes a value that maps to configuration data that identifies a plurality of responder nodes to send the reply data.

Clause 12. The method of clause 11, wherein the configuration data maps to an order of the reply data from the responder node relative to other reply data in the subscriber message frame.

Clause 13. A method, comprising: sending a header part of a subscriber message frame with an identifier field that specifies multiple responder nodes of a communications network to send reply data; and receiving, in a response part of the subscriber message frame, the reply data from the multiple responder nodes specified by the identifier field.

Clause 14. The method of clause 13, wherein the identifier field specifies an order of the reply data from the multiple responder nodes.

Clause 15. The method of any of clauses 13 and 14, further comprising: receiving one or more checksum bits as part of the reply data from the multiple responder nodes.

Clause 16. The method of any of clauses 13-15, further comprising: receiving the reply data from the multiple responder nodes in a plurality of data slots in the subscriber message frame.

Clause 17. The method of any of clauses 13-16, wherein the communications network includes a number of N responder nodes, and the identifier field specifies less than all of the N responder nodes to send the reply data as part of the subscriber message frame.

Clause 18. The method of any of clauses 13-17, wherein the identifier field includes a value that maps to a configuration file that specifies the multiple responder nodes are to send the subscriber message frame.

Clause 19. The method of clause 18, wherein the configuration file specifies an order of the multiple responder nodes to append the reply data in the subscriber message frame.

Clause 20. A communications system, comprising: a commander node configured to send a header of a subscriber message frame with an identifier field that specifies that multiple responder nodes are to send reply data to the commander node; and multiple responder nodes that are configured to send reply data to the commander node in a responder part of the subscriber message frame.

Clause 21. A responder node configured to: receive a header of a subscriber message frame with an identifier field that specifies the responder node is to send reply data to a commander node; and send the reply data as part of a reply message frame that includes other reply data from at least one other responder node specified by the identifier field of the subscriber message frame.

Clause 22. A commander node configured to: send a subscriber message frame with a header that includes an identifier field that specifies multiple responder nodes of a communications network to send reply data; and receive reply data from the multiple responder nodes specified by the identifier field in a response part of the subscriber message frame.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
receiving, by a responder node, a header part of a subscriber message frame with an identifier field that specifies the responder node is to send reply data to a commander node; and
sending, by the responder node during a response part of the subscriber message frame, the reply data along with other reply data from at least one other responder node specified by the identifier field.

2. The method of claim 1, wherein the identifier field maps to an order of the reply data from the responder node relative to the other reply data in the subscriber message frame.

3. The method of claim 2, wherein the reply data is after prior reply data in the order, and the method further includes appending the reply data after the prior reply data has been output as part of the response part of the subscriber message frame.

4. The method of claim 1, further comprising:
sending one or more checksum bits at an end of the subscriber message frame.

5. The method of claim 4, wherein the responder node is one of multiple of responder nodes specified by the identifier field to send reply data, and further comprising:
sending the one or more checksum bits by each of a plurality of responder nodes at an end of the subscriber message frame.

6. The method of claim 5, further comprising:
identifying, by a commander node, a transmission error if the checksum bits from at least one of the multiple of responder nodes indicates a checksum mismatch.

7. The method of claim 4, further comprising:
sending first checksum bits as part of the reply data from the responder node; and
sending second checksum bits as part of the other reply data from the at least one other responder node.

8. The method of claim 1, wherein identifier field maps to a multiple responder nodes to send reply data, and response part of the subscriber message frame includes a plurality of data slots that correspond to reply data of the multiple responder nodes.

9. The method of claim 8, wherein the plurality of data slots each include at least a byte of data.

10. The method of claim 1, wherein the responder node is part of a communications system that includes a number of N responder nodes, and the identifier field specifies less than all of the N responder nodes to send reply data as part of the subscriber message frame.

11. The method of claim 1, wherein the identifier field includes a value that maps to configuration data that identifies a plurality of responder nodes to send the reply data.

12. The method of claim 11, wherein the configuration data maps to an order of the reply data from the responder node relative to other reply data in the subscriber message frame.

13. A method, comprising:
sending a header part of a subscriber message frame with an identifier field that specifies multiple responder nodes of a communications network to send reply data; and
receiving, in a response part of the subscriber message frame, the reply data from the multiple responder nodes specified by the identifier field.

14. The method of claim 13, wherein the identifier field specifies an order of the reply data from the multiple responder nodes.

15. The method of claim 13, further comprising:
receiving one or more checksum bits as part of the reply data from the multiple responder nodes.

16. The method of claim 13, further comprising:
receiving the reply data from the multiple responder nodes in a plurality of data slots in the subscriber message frame.

17. The method of claim 13, wherein the communications network includes a number of N responder nodes, and the identifier field specifies less than all of the N responder nodes to send the reply data as part of the subscriber message frame.

18. The method of claim 13, wherein the identifier field includes a value that maps to a configuration file that specifies the multiple responder nodes are to send the subscriber message frame.

19. The method of claim 18, wherein the configuration file specifies an order of the multiple responder nodes to append the reply data in the subscriber message frame.

20. A communications system, comprising:
a commander node configured to send a header of a subscriber message frame with an identifier field that specifies that multiple responder nodes are to send reply data to the commander node; and
multiple responder nodes that are configured to send reply data to the commander node in a responder part of the subscriber message frame.

21. A responder node configured to:
receive a header of a subscriber message frame with an identifier field that specifies the responder node is to send reply data to a commander node; and
send the reply data as part of a reply message frame that includes other reply data from at least one other responder node specified by the identifier field of the subscriber message frame.

22. A commander node configured to:
send a subscriber message frame with a header that includes an identifier field that specifies multiple responder nodes of a communications network to send reply data; and
receive reply data from the multiple responder nodes specified by the identifier field in a response part of the subscriber message frame.
